(19) United States
(12) Patent Application Publication
(10) Pub. No.: US 2006/0136599 A1
(43) Pub. Date: Jun. 22, 2006

(54) System and method of transferring packet through proxy server

(76) Inventor: Chung-Chih Tung, Taipei (TW)

Correspondence Address: RABIN & BERDO, P.C., Suite 500, 1101 14 Street, N.W., Washington, DC, 20005, US

(21) Appl. No.: 11/018,243

(22) Filed: Dec. 22, 2004

(51) Int. Cl. G06F 15/173; G06F 15/16

(52) U.S. Cl. 709/245; 709/238; 709/242

(57) ABSTRACT

A system and method for transferring packet through a proxy server. By installing a proxy client device or control software on a broadband router of the user computer, and using a proxy server that includes network address translation (NAT) technology, the proxy server interacts with the proxy client to hide the user computer from being transparent to the Internet.

### FIELD OF THE INVENTION

The invention generally relates to technology of packet transference, and in particular relates to a system and method for transferring packet through a proxy server.

### BACKGROUND OF THE INVENTION

As shown in FIG. 1 of prior arts, a general user computer 110 communicates with a target computer 120 through a broadband router 140 and Internet 130. The broadband router 140 linked to the user computer 110 has an entity IP address provided by an Internet service provider. The broadband router 140 allocates a virtual IP address to the user computer 110 through network address translation (NAT) technology. The user computer 110 then communicates with the target computer through the broadband router 140 and Internet 130 by hiding its IP address.

However, such operation is not a safe mechanism to prevent interception. Internet hackers easily find out the IP address of the broadband router 140 and obtain the IP address of the user computer 110 behind the broadband router 140. Thus the hackers can reach the data in the user computer 110.

Therefore, under the conditions that a common user doesn't want to spend a lot of money purchasing firewall software, how to create a firewall mechanism with simple construction is a question that prior arts did not discuss or research. This is a demand to be solved.

In view of the aforesaid technical problem, the invention provides a system and method for transferring packet through a proxy server. The system and method installs a specific proxy client device or control software on the broadband router. In accompany with a proxy server that applies translation technology, the proxy client works with the proxy server to hide and protect the user computer.

### SUMMARY OF THE INVENTION

The object of the invention is to provide a system and method for transferring packet through a proxy server. The system and method does not use a firewall mechanism while achieves the object of preventing the user's personal computer from interception by hackers.

To achieve the aforesaid object, the invention installs a proxy client device or control software on a broadband router of the user computer. The broadband router including the proxy client transfers the packet from the user computer. A proxy server on the network processes the packet transferred from the proxy client so as to achieve the data transferring and receiving.

A proxy server system of the invention mainly includes a receiving and recognition unit, a replacing unit, a transference unit, a recording unit and an encryption/decryption module. The method of packet receiving and transference through the proxy server mainly includes the following method of transferring packet to the proxy client and the method of transferring packet to the non-proxy client. The method of transferring packet to the non-proxy client includes steps of receiving packet and identifying the packet coming from the proxy client; comparing with an IP address translation table and replacing the source IP address; and finally transferring the packet to the target computer at the IP address.

The method of transferring packet to the proxy client includes the following steps: receiving packet and identifying the packet not coming from the proxy client; referring to a transference task list and confirming the source packet to be transferred; comparing with an IP address translation table and replacing the target IP address; encrypting the packet and finally transferring the packet.

The system and method the invention as briefly described above can solve the problem of prior arts. It achieves the following effects without the need of a powerful or expensive firewall software:

1) achieves the requirement of transferring packet;

2) achieves the requirement of hiding the IP address of user computer;

3) achieves the requirement of preventing hackers from reaching the packet data; and

4) achieves the requirement of preventing hackers from attacking the user computer.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1A is a schematic drawing of data transference in prior arts between a user computer and a target computer through a broadband router;

FIG. 1B schematic drawing of data transference in the invention between a user computer and a target computer;

FIG. 2 is a systematic diagram of a proxy server in the invention;

FIG. 3 is a flowchart of packet transference in the invention through a broadband router to a proxy server;

FIG. 4 is a flowchart of packet transference in the invention through a broadband router to a user computer;

FIG. 5 is a flowchart of packet transference in the invention through a proxy server to a target computer; and

FIG. 6 is a flowchart of packet transference in the invention through a proxy server to a proxy client.

### DETAILED DESCRIPTION OF THE INVENTION

The invention provides a system and method for transferring packet through a proxy server. By installing a proxy client device or control software on a broadband router of the user computer, and using a proxy server that includes network address translation (NAT) technology, the proxy server interacts with the proxy client to hide the user computer from being transparent to the Internet. The system and method of the invention does not use a firewall mechanism while achieves the object of preventing the personal computer from interception by hackers.

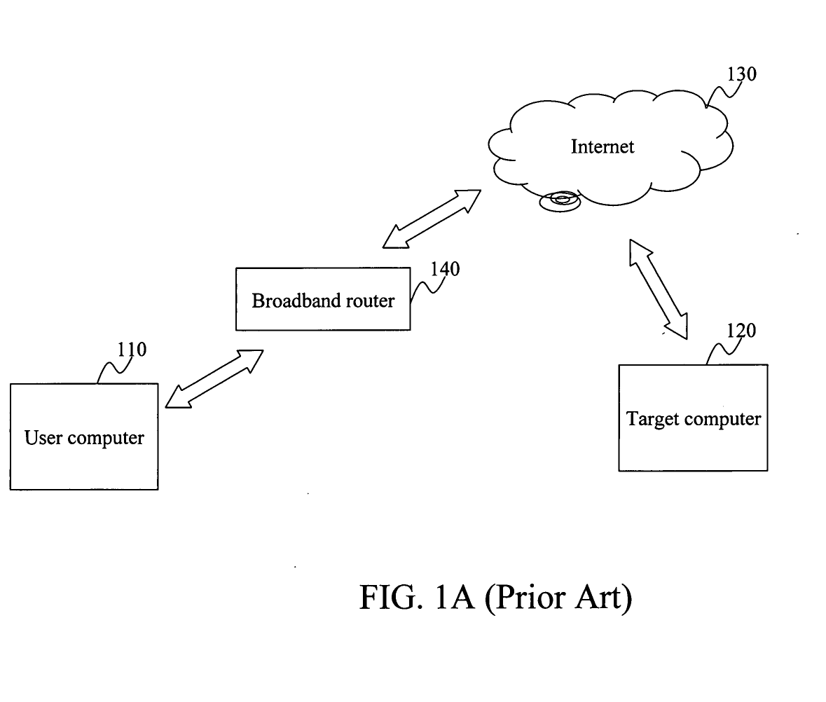

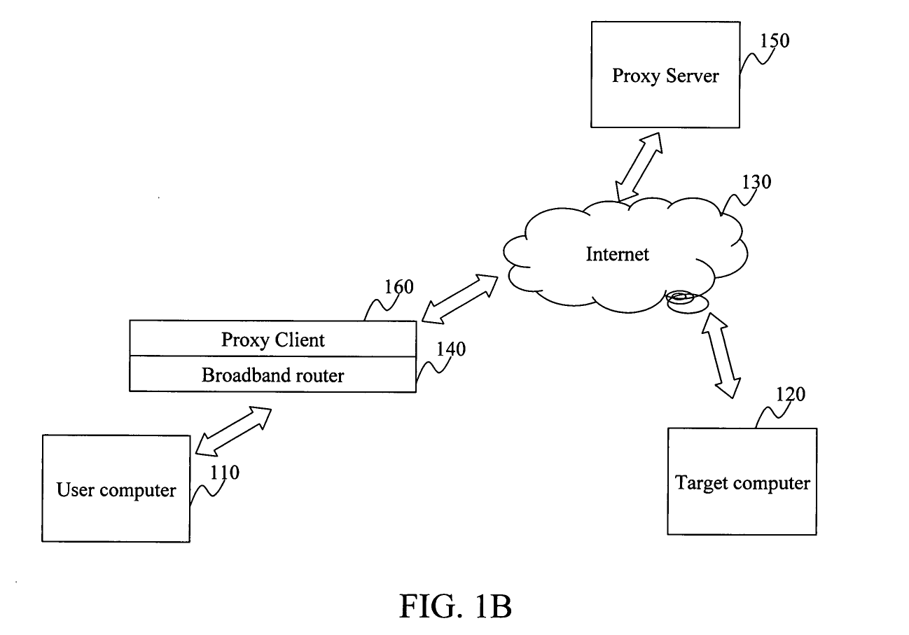

The operation and functions of a system and method of the invention will be described below. As shown in FIG. 1B, a user computer 110 and a target computer 120 are communicated through an environment of the invention. The major difference of the invention from conventional environment is that a broadband router 140 is covered by a device or software of proxy client 160. A proxy server 150 on the network correspondent to the proxy client 160 processes the packet transference between the user computer 110 and the target computer 120.

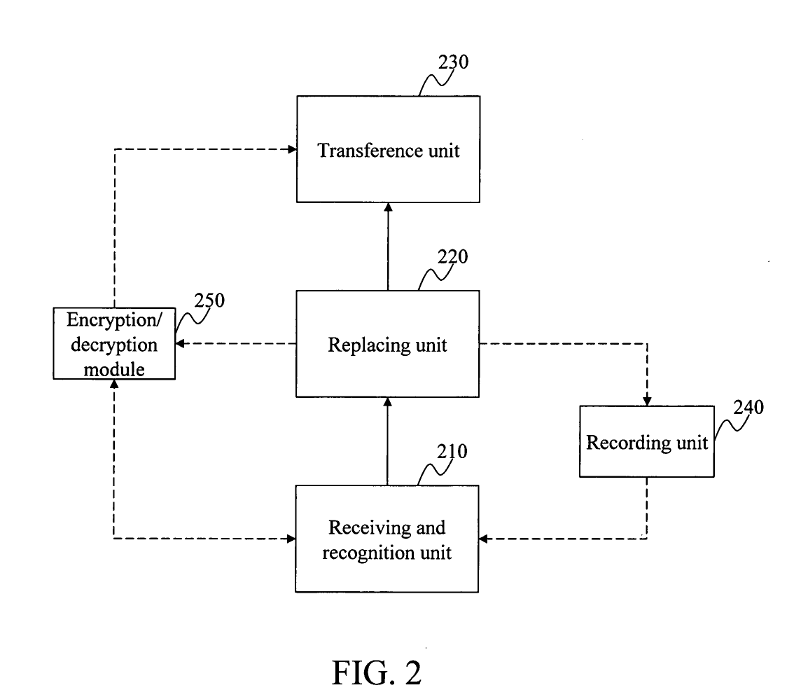

FIG. 2 is a systematic diagram of a proxy serverl50 in the invention. The proxy server 150 mainly includes a receiving and recognition unit 210, a replacing unit 220, a transference unit 230, a recording unit 240 and an encrytion/decryption module 250.

A conventional proxy server mainly includes a receiving and recognition unit, a transference unit and a recording unit only. The receiving and recognition unit 210 mainly receives the information request of the user computer 110 and recognizes whether the requested information exists in the databank of the proxy server 150. The transference unit 230 mainly transfers information from the proxy server databank or from other network resources to the user computer 110, or transfers the request to other network resources. The recording unit 240 mainly records the information request of the user computer that is frequently asked so as to obtain it from the known network resources and to store it in the proxy server 150 databank for facilitating a fast response to user computer 110 afterwards. In a conventional proxy server, the aforesaid units only provide the service to help the user computer downloading commonly used network resources to the proxy server 150 and to reduce the bandwidth use rate of the network facility.

In the invention, the proxy server 150 further includes network address translation (NAT) technology to provide once more packet translation and enhance the safety and secrecy of the user computer. Therefore, the receiving and recognition unit 210 of the proxy server 150 receives packet and recognizes the IP address of source or target computer. The replacing unit 220 is used to replace the packet source or target IP address. The transference unit 230 is used to transfer the packet to the target computer 120.- The recording unit 240 is used to record the packet information of replaced IP address and finishes the transference after the target computer replies. The encryption module 250 is used to encrypt the packet.

Therefore, when the proxy server of the invention starts to work, the receiving and recognition unit 210 receives the packet transferred to the proxy server 150 and identifies whether the packet is a packet originally transferred from the proxy client 160 according to the record of the recording unit 240. If confirmed, the replacing unit 220 replaces the source IP address in the packet. The recording unit 240 records the replacement information and passes to the transference unit 230 for transferring the packet to the target computer 120. When the receiving and recognition unit 210 receives the packet and recognizes an encrytion, the encrytion/decrytion module 250 decrypts the packet for further process.

When the receiving and recognition unit 210 identifies that the received packet is not transferred from the proxy client 160 but is requested by the proxy client 160, the packet is passed to the replacing unit 220 for replacing the target IP address. The transference unit 230 then transfers the packet to the broadband router 140 of the proxy client 160. Before the packet being passed to the transference unit 230, the encrytion/decrytion module 250 first decrypts the packet for further transference.

When the receiving and recognition unit 210 identifies that the received packet is not transferred from the proxy client 160 nor requested by the proxy client 160, the proxy server neglects the packet without taking further action.

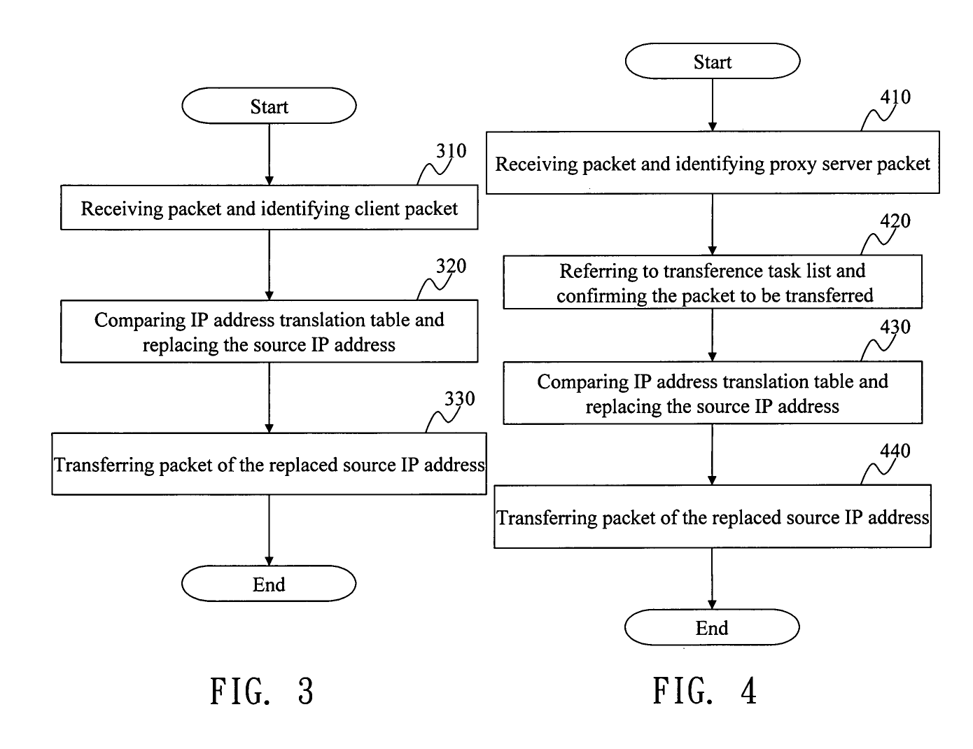

In addition to the above description of the system and environment of the invention, the process of the invention will be further described below. First with FIG. 3 (please also refer to FIG. 1B), a flowchart of a packet transferred from a user computer 110 to a proxy server 150 through a broadband router 140. The broadband router 140 receives a packet and identifies the packet of user computer (step 310). It compares with an IP address translation table and replaces the source IP address with the proxy client IP address (step 320). Finally, transfers the packet to the proxy server 150 (step 330) and records the packet transference information to the transference task list of the broadband router 140. The transference information includes source IP address, target IP address, time of packet transference and record of unfinished transference.

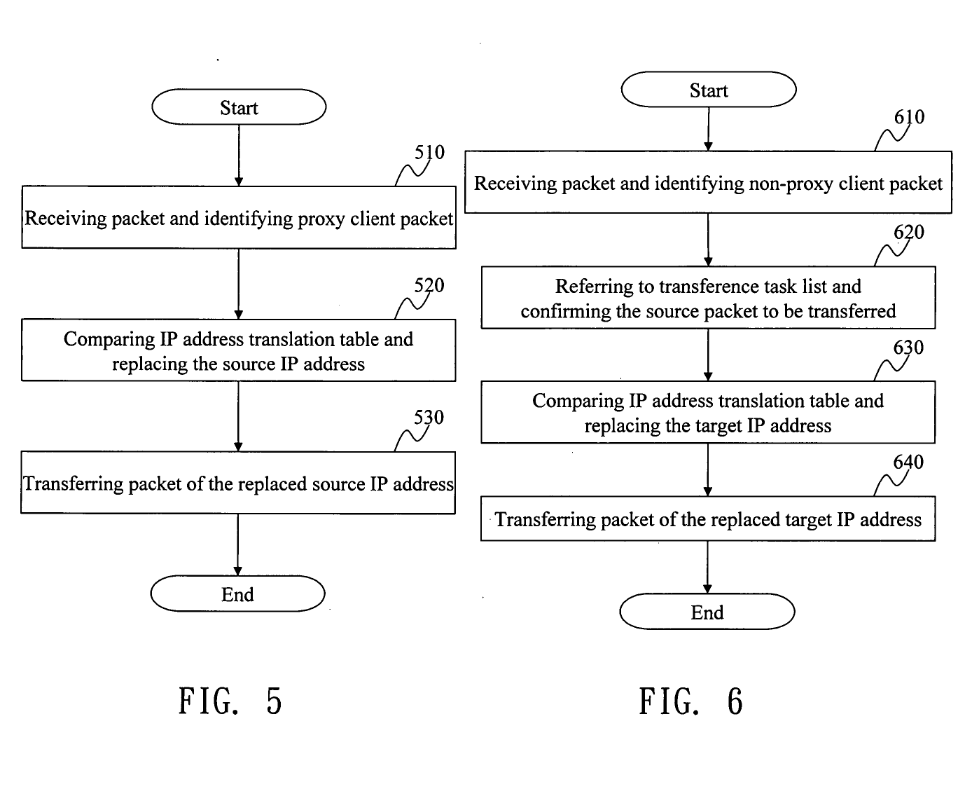

FIG. 5 is a flowchart of packet transference in the invention through a proxy server 150 to a target computer 120. The proxy server 150 receives a packet and identifies the packet of proxy client 160 (step 510). It compares with an IP address translation table and replaces the proxy client IP address with the proxy server IP address (step 520). Finally, transfers the packet to the target computer 120 (step 530) and records the packet transference information to the transference task list of the proxy server 150.

FIG. 6 is a flowchart of packet transference in the invention through a proxy server 150 to a proxy client 160. The proxy server 150 receives a packet and identifies that the packet is not from the proxy client 160 (step 610). It refers to the transference task list and confirms the packet to be transferred (step 620). It compares with an IP address translation table, replaces the target IP address with the proxy sever IP address (step 630) and cleans a transference information in the transference task list. Finally, transfers the packet to the broadband router 160 incorporated with the proxy client 160 (step 640).

FIG. 4 is a flowchart of packet transference in the invention through a broadband router 140 to a user computer 110. The broadband router 140 receives a packet and identifies the packet of proxy server 150 (step 410). It refers to the transference task list and confirms the packet to be transferred (step 420). It compares with an IP address translation table and replaces the proxy server IP address with the proxy client IP address (step 430). Finally, transfers the packet to the user computer 110 (step 440).

During packet transferences between the proxy client 160 and the proxy server 150, the packet can be encrypted before transference and decrypted after being received so as to enhance the safety.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A packet transference system applying in a proxy server, comprising:
a receiving and recognition unit, for receiving a packet and identifying the packet source;
a replacing unit, for replacing IP address of said packet according to an IP address translation table;
a transference unit, for transferring said packet; and
a recording unit, for recording a packet transference record to a transference task list.

2. The packet transference system of claim 1, further comprises an encryption/decryption module for encrypting and decrypting said packet.

3. The packet transference system of claim 1 claim 1, wherein said IP address is a source IP address.

4. The packet transference system of claim 1, wherein said IP address is a target IP address.

5. A packet transference method, applying in a proxy server for transferring a packet to a target computer, comprising steps of:
receiving said packet and comparing with a transference task list;
identifying said packet transferred from a proxy client;
replacing a source IP address according to an IP address translation table;
recoding a transference information to said transference task list; and
transferring said packet with the replaced source IP address to a target IP address.

6. The packet transference method of claim 5, wherein said step of receiving a packet and comparing with a transference task list further comprises a step of decrypting an encrypted packet.

7. The packet transference method of claim 5, wherein said transference information comprises said source IP address, a target IP address, a time of packet transference and a record of unfinished transference.

8. A packet transference method, applying in a proxy server for transferring a packet to a proxy client, comprising steps of:
receiving said packet and comparing with a transference task list;
identifying said packet not transferred from a proxy client;
replacing a target IP address according to an IP address translation table;
cleaning a transference information in said transference task list; and
transferring said packet with the replaced target IP address to said proxy client.

9. The packet transference method of claim 8, wherein said step of transferring said packet with replaced target IP address to said proxy client further comprises a step of encrypting said packet.

10. The packet transference method of claim 8, wherein said transference information comprises said source IP address, a target IP address, a time of packet transference and a record of unfinished transference.
